(19) United States
(12) Patent Application Publication
(10) Pub. No.: US 2025/0011569 A1
(43) Pub. Date: Jan. 9, 2025

(54) RESIN COMPOSITION, FILM, METHOD FOR PRODUCING FILM, AND LAMINATE

(71) Applicant: MITSUBISHI CHEMICAL CORPORATION, Tokyo (JP)

(72) Inventor: Junichi ABE, Tokyo (JP)

(73) Assignee: MITSUBISHI CHEMICAL CORPORATION, Tokyo (JP)

(21) Appl. No.: 18/882,854

(22) Filed: Sep. 12, 2024

Related U.S. Application Data
(63) Continuation of application No. PCT/JP2023/006622, filed on Feb. 24, 2023.

(30) Foreign Application Priority Data
Mar. 30, 2022 (JP) 2022-057413

(51) Int. Cl. C08K 5/00; C08J 5/22; C08K 3/22; C08K 5/16; C08L 101/02

(52) U.S. Cl. CPC C08K 5/0041; C08J 5/22; C08K 3/22; C08J 2369/00; C08K 2003/2237; C08K 5/16; C08L 101/025

(57) ABSTRACT

Provided is a colored resin product which contains a fluorescent dye and in which color fading over time is suppressed. A resin composition includes: a polycarbonate resin (A) containing a structural unit (a) derived from a specific dihydroxy compound represented by formula (1); and a fluorescent dye (B). A laminate (10) is configured in which the film (11) composed of the resin composition, the retroreflective element layer (12), and the substrate (13) are layered in this order.

This application is a Continuation of PCT International Application No. PCT/JP2023/006622 filed in Japan on Feb. 24, 2023, which claims the benefit of Patent Application No. 2022-057413 filed in Japan on Mar. 30, 2022, the entire contents of which are hereby incorporated by reference.

### DESCRIPTION

### Technical Field

The present invention relates to a resin composition, a film, a method for producing a film, and a laminate.

### Background Art

A film containing a fluorescent dye has conventionally been used for a sign or the like. Such a film containing a fluorescent dye or a coloring agent is required to exhibit a desired color and is required to have weather resistance when used outdoors. As such a colored film, an acrylic resin film for a retroreflective sheet that has a fluorescent color and has good visibility and good weather resistance is known (see, for example, Patent Literature 1). Further, as a colored film, a black resin composition containing a copolymerized polycarbonate resin and a black coloring agent is known (see, for example, Patent Literature 2).

### CITATION LIST

### Patent Literatures

### [Patent Literature 1]

International Publication No. WO 2020/022063

### [Patent Literature 2]

Japanese Patent Application Publication No. 2015-172150

### SUMMARY OF INVENTION

### Technical Problem

However, in the colored film disclosed in Patent Literature 1, color fading of the fluorescent dye may occur due to exposure in an outdoor environment. The colored film of Patent Literature 2 shows a black appearance. Patent Literature 2 does not mention the presence or absence of color fading. Thus, the conventional art still has room for improvement from the viewpoint of suppressing color fading of a colored film containing a fluorescent dye.

An object of an aspect of the present invention is to provide a colored resin product that contains a fluorescent dye and suppresses color fading over time.

### Solution to Problem

In order to solve the above-described problem, a resin composition in accordance with an aspect of the present invention comprises: a polycarbonate resin (A) containing a structural unit (a) derived from a dihydroxy compound represented by the following formula (1); and a fluorescent dye (B).

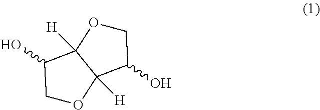

Further, in order to solve the above-described problem, a film in accordance with an aspect of the present invention comprises the above-described resin composition.

Further, in order to solve the above-described problem, a method for producing a film in accordance with an aspect of the present invention is such that the above-described film is produced by a T-die method.

Further, in order to solve the above-described problem, a laminate in accordance with an aspect of the present invention is a laminate comprising: the above-described film; and a retroreflective sheet.

### Advantageous Effects of Invention

According to this aspect, it is possible to provide a colored resin product that contains a fluorescent dye and suppresses color fading over time.

### BRIEF DESCRIPTION OF DRAWINGS

FIG. 1 is a diagram schematically illustrating a layer configuration of an example of a laminate in accordance with an embodiment of the present invention.

FIG. 2 is a diagram illustrating chromaticities of laminates of Examples and Comparative Examples before an exposure test.

FIG. 3 is a diagram illustrating chromaticities of laminates of Examples and Comparative Examples after the exposure test.

### DESCRIPTION OF EMBODIMENTS

The following description will explain in detail an embodiment of the present invention. In the present specification, the expression “A to B” means a range expressed as “more than or equal to A (inclusive) and less than or equal to B (inclusive)”.

### [Resin Composition]

A resin composition in accordance with an aspect of the present invention contains a polycarbonate resin (A) and a fluorescent dye (B).

### [Polycarbonate Resin (A)]

A polycarbonate resin (A) in accordance with an aspect of the present invention contains a structural unit (a) derived from a dihydroxy compound represented by the following formula (1):

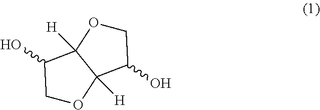

In the present specification, a “structural unit” means a partial structure that constitutes a resin and is a specific partial structure contained in a repeating structural unit of a resin. For example, the “structural unit” is a partial structure sandwiched between adjacent linking groups in a resin or a partial structure sandwiched between a polymerizable reactive group present at a terminal portion of a polymer and a linking group adjacent to the polymerizable reactive group. More specifically, in the case of the polycarbonate resin (A), a carbonyl group is a linking group, and the “structural unit” is a partial structure sandwiched between adjacent carbonyl groups.

<Structural Unit (a)>

Examples of the dihydroxy compound represented by the formula (1) include isosorbide, isomannide, and isoidet. These are stereoisomers to each other. The dihydroxy compound may be one of these stereoisomers or may be two or more of these stereoisomers. Among them, isosorbide that is obtained by dehydration condensation of sorbitol produced from various types of easily available starch which are abundant as a plant-derived resource is most preferable from the viewpoint of obtainability and producibility, moldability, and properties of obtained molded articles (e.g., heat resistance, impact resistance, surface hardness, and carbon neutral).

<Structural Unit (b)>

The polycarbonate resin (A) may further contain another structural unit, provided that an effect of the present invention is obtained. For example, the polycarbonate resin (A) may further contain a structural unit (b) derived from at least one type of dihydroxy compound selected from a group consisting of aliphatic hydrocarbon dihydroxy compounds, alicyclic hydrocarbon dihydroxy compounds, and ether-containing dihydroxy compounds.

The dihydroxy compounds from which the structural unit (b) is derived each have a flexible molecular structure. The polycarbonate resin (A) is preferably a copolymerized polycarbonate resin containing the structural unit (a) and the structural unit (b), from the viewpoint of improving the chemical resistance of the polycarbonate resin (A). From such a viewpoint, the dihydroxy compound from which the structural unit (b) is derived is more preferably aliphatic hydrocarbon dihydroxy compounds and alicyclic hydrocarbon dihydroxy compounds, and still more preferably alicyclic hydrocarbon dihydroxy compounds.

Examples of the aliphatic hydrocarbon dihydroxy compounds include linear aliphatic dihydroxy compounds and aliphatic dihydroxy compounds having a branched chain. Examples of the linear aliphatic dihydroxy compounds include ethylene glycol, 1,3-propanediol, 1,2-propanediol, 1,4-butanediol, 1,5-heptanediol, 1,6-hexanediol, 1,9-nonanediol, 1,10-decane diol, and 1,12-dodecanediol. Examples of the aliphatic dihydroxy compounds having a branched chain include 1,3-butanediol, 1,2-butanediol, neopentyl glycol, and hexylene glycol.

Examples of the alicyclic hydrocarbon dihydroxy compounds include dihydroxy compounds that are alicyclic hydrocarbon primary alcohols and dihydroxy compounds that are alicyclic hydrocarbon secondary alcohols or tertiary alcohols. Examples of the dihydroxy compounds that are alicyclic hydrocarbon primary alcohols include dihydroxy compounds derived from terpene compounds. Examples of the terpene compounds include 1,2-cyclohexanedimethanol, 1,3-cyclohexanedimethanol, 1,4-cyclohexanedimethanol, tricyclodecanedimethanol, pentacyclopentadecanedimethanol, 2,6-decalin dimethanol, 1,5-decalin dimethanol, 2,3-decalin dimethanol, 2,3-norbornane dimethanol, 2,5-norbornane dimethanol, 1,3-adamantane dimethanol, and limonene. Examples of the alicyclic hydrocarbon secondary alcohols or tertiary alcohols include 1,2-cyclohexanediol, 1,4-cyclohexanediol, 1,3-adamantanediol, hydrogenated bisphenol A, and 2,2,4,4-tetramethyl-1,3-cyclobutanediol.

Examples of the ether-containing dihydroxy compounds include oxyalkylene glycols. Examples of the oxyalkylene glycols include diethylene glycol, triethylene glycol, tetraethylene glycol, polyethylene glycol, and polypropylene glycol.

The dihydroxy compound from which the structural unit (b) is derived is, among the dihydroxy compounds listed above, preferably 1,4-cyclohexanedimethanol and tricyclodecanedimethanol, and more preferably 1,4-cyclohexanedimethanol. For example, when the dihydroxy compound from which the structural unit (b) is derived is 1,4-cyclohexanedimethanol, good polymerization reactivity of 1,4-cyclohexanedimethanol makes it easy to obtain a high-molecular weight polycarbonate resin (A). Further, when the dihydroxy compound from which the structural unit (b) is derived is 1,4-cyclohexanedimethanol, it is possible to obtain a polycarbonate resin (A) that is extremely excellent in mechanical properties such as impact resistance, and an effect of suppressing warpage in a laminate described later is more sufficiently exhibited.

Note that both the dihydroxy compound represented by the formula (1) and the dihydroxy compound from which the structural unit (b) is derived may contain a stabilizer from the viewpoint of further improving the quality of the resin composition. Examples of the stabilizer include a reducing agent, an antioxidant, a deoxygenating agent, a light stabilizer, an acid suppressant, a pH stabilizer, and a thermal stabilizer. In particular, the dihydroxy compound represented by the formula (1) has a property of easily degrading in an acidic condition. Therefore, using a basic stabilizer in a production process for the polycarbonate resin (A) is preferable from the viewpoint of suppressing the degradation of the dihydroxy compound in the production process.

### <Another Structural Unit>

Examples of the another structural unit that may be contained in the polycarbonate resin (A) include structural units derived from a dihydroxy compound containing an aromatic group such as a bisphenol compound, a structural unit derived from a dicarboxylic acid compound, and a structural unit derived from a diester compound. A polycarbonate resin into which a structural unit derived from a diester compound is partially incorporated is also referred to as a polyester carbonate resin. The polycarbonate resin (A) can encompass such a polyester carbonate resin.

For example, the polycarbonate resin (A) preferably further contains a structural unit derived from a dihydroxy compound containing an aromatic group or a structural unit derived from a dicarboxylic acid compound, from the viewpoint of increasing the heat resistance of the polycarbonate resin (A). From such a viewpoint, the amount of these structural units in the polycarbonate resin (A) is preferably less than or equal to 10% by mass, and more preferably less than or equal to 5% by mass.

<Amount Ratio Between Structural Unit (a) and Structural Unit (b)>

A proportion between the structural unit (a) and the structural unit (b) in the polycarbonate resin (A) is preferably within a range of 40/60 to 90/10, from the viewpoint of sufficiently increasing the physical properties of a resin composition. The proportion herein is a molar ratio of the structural unit (a) to the structural unit (b) (structural unit (a)/structural unit (b)). A molar ratio falling within the above-described range is suitable from the viewpoint of realizing a resin composition that has sufficient heat resistance, mechanical properties, and moldability in practical use and further has sufficient moist heat resistance and chemical resistance. In addition, the molar ratio falling within the above-described range is preferable from the viewpoint of suppressing color fading over time of a resin composition. From such a viewpoint, the above-described molar ratio is more preferably more than or equal to 42/58, and still more preferably more than or equal to 45/55. From the same viewpoint, the above-described molar ratio is more preferably less than or equal to 85/15, and still more preferably less than or equal to 80/20.

### <Weight Average Molecular Weight (Mw)>

The weight average molecular weight of the polycarbonate resin (A) is preferably more than or equal to 20,000, more preferably more than or equal to 25,000, and still more preferably more than or equal to 30,000, from the viewpoint of increasing impact resistance, chemical resistance, and moist heat resistance. The weight average molecular weight of the polycarbonate resin (A) is preferably less than or equal to 100,000, more preferably less than or equal to 80,000, and still more preferably less than or equal to 60,000, from the viewpoint of exhibiting good fluidity during the production of a resin composition and a film.

The weight average molecular weight of the polycarbonate resin (A) is a standard polystyrene-equivalent value measured by gel permeation chromatography (GPC) under the following GPC measurement conditions. Further, the weight average molecular weight of the polycarbonate resin (A) can be adjusted by, for example, the amount of a polymerization catalyst used during the production of the polycarbonate resin (A).

### (GPC Measurement Conditions)

Device used: HLC-8320 GPC system manufactured by Tosoh Corporation

Column: 2 columns of TSKgel Super HZM-H (trade name, manufactured by Tosoh Corporation)

Eluent: tetrahydrofuran

Column temperature: 40° C.

Detector: differential refractive index (RI)

### <Glass Transition Temperature (Tg)>

A glass transition temperature (hereinafter also referred to as “Tg”) of the polycarbonate resin (A) is preferably more than or equal to 90° C., more preferably more than or equal to 92° C., and still more preferably more than or equal to 95° C., from the viewpoint of sufficiently increasing the heat resistance of the resin composition. Further, the glass transition temperature of the polycarbonate resin (A) is preferably less than or equal to 150° C., more preferably less than or equal to 145° C., and still more preferably less than or equal to 140° C., from the viewpoint of easiness of molding processing of the resin composition.

The glass transition temperature of the polycarbonate resin (A) is a value calculated from a FOX formula using a value described in a polymer handbook [Polymer HandBook (J. Brandrup, Interscience, 1989)]. The Tg of the polycarbonate resin (A) can be adjusted by changing, for example, the types of dihydroxy compounds or the ratio between structural units derived therefrom.

### <Production Method>

The polycarbonate resin (A) can be synthesized by polycondensing the above-described dihydroxy compound and diester carbonate by a transesterification reaction. In addition to polycondensation, a monohydroxy compound and are by-products in the the like which transesterification reaction are removed out of a system.

The polycarbonate resin (A) may be a commercially available product.

The diester carbonate used as a raw material in the synthesis of the polycarbonate resin (A) may be one type of diester carbonate or may be two or more types of diester carbonates. Examples of the diester carbonate include: substituted diphenyl carbonate such as diphenyl carbonate (DPC) and ditolyl carbonate; and alkyl carbonate such as dimethyl carbonate, diethyl carbonate, and di-tert-butyl carbonate. Among these diester carbonates, diphenyl carbonate or substituted diphenyl carbonate is preferable, and diphenyl carbonate is more preferable.

### [Fluorescent Dye (B)]

The fluorescent dye (B) can be selected as appropriate from known fluorescent dyes according to the application of the resin composition. For example, in a case where the aforementioned resin composition is used for a skin material on a retroreflective sheet in a retroreflective member, the fluorescent dye (B) can be selected as appropriate from the well-known fluorescent dyes in consideration of chromaticity coordinates (x, y) required as the retroreflective sheet. The fluorescent dye (B) may be one type of fluorescent dye or may be two or more fluorescent dyes. Note that the retroreflective member is a member that has a retroreflective sheet and a skin material which is disposed so as to be stacked on the retroreflective sheet and which has a desired color, and corresponds to a laminate described later.

The fluorescent dye (B) preferably contains at least one type of dye selected from a group consisting of a thioxanthene-based dye, a thioindigoid-based dye, an anthraquinone-based dye, a benzoxazole coumarin-based dye, a perylene-based dye, a peryleneimide-based dye, a benzopyran-based dye, an anthracene dye, and an isoquinoline-based dye, in terms of excellent transparency and excellent hue.

The thioxanthene-based dye means a dye that contains a compound having a thioxanthene skeleton in a molecule. The thioindigoid-based dye means a dye that contains a compound having a thioindigo skeleton in a molecule. The anthraquinone-based dye means a dye that contains a compound having an anthraquinone skeleton in a molecule. The benzoxazole coumarin-based dye means a dye that contains a compound having a 3-(benzoxazole-2-yl) coumarin skeleton in a molecule. The perylene-based dye means a dye that contains a compound having a perylene skeleton in a molecule. However, those corresponding to the following peryleneimide-based dye are excluded. The peryleneimide-based dye means a dye that contains a compound having a perylenetetracarboxydiimide skeleton in a molecule. The benzopyran-based dye means a dye that contains a compound having a benzopyran skeleton in a molecule. However, those corresponding to the above-described benzoxazole coumarin-based dye are excluded. The anthracene dye means a dye that contains a compound having an anthracene skeleton in a molecule. The isoquinoline-based dye means a dye that contains a compound having an isoquinoline skeleton in a molecule.

In a case where the resin composition is used for the skin material in the retroreflective member, the fluorescent dye (B) preferably contains one or both of a yellow fluorescent dye and a red fluorescent dye, from the viewpoint of achieving suitable chromaticity coordinates (x, y) in such an application. Further, in another aspect, the fluorescent dye (B) preferably contains one or both of a yellow fluorescent dye and a red fluorescent dye and does not contain other fluorescent dyes, from the above-described viewpoint. Note that the yellow fluorescent dye means a dye whose color shade is yellow in a color index name. Further, the red fluorescent dye means a dye whose color shade is red in the color index name.

As the fluorescent dye (B), a commercially available product can be used. Examples of the commercially available product of the fluorescent dye (B) include: C.I. Solvent Yellow 98 (“DYMIC MBR D-70” manufactured by Dainichiseika Kogyo Co., Ltd.) which exemplifies the thioxanthene-based dye; C.I. Solvent Orange 63 (“DYMIC MBR D-74” manufactured by Dainichiseika Kogyo Co., Ltd.) which exemplifies the anthraquinone-based dye; C.I. Solvent Orange 55 (“DYMIC MBR 120830 Orange” manufactured by Dainichiseika Kogyo Co., Ltd.) and “Lumogen (registered trademark) F Yellow 083” and “Lumogen F Yellow 170” manufactured by BASF which exemplify the perylene-based dye; “Lumogen F Orange 240” and “Lumogen F Red 305” manufactured by BASF which exemplify the peryleneimide-based dye; C.I. Solvent Red 197 (“DYMIC MBR D-75” manufactured by Dainichiseika Kogyo Co., Ltd.) which exemplifies the benzopyran-based dye; C.I. Solvent Red 196 (“DYMIC MBR D-77” manufactured by Dainichiseika Kogyo Co., Ltd.) which exemplifies the anthracene dye; and C. I. Solvent Yellow 104 (“DYMIC MBR D-71” manufactured by Dainichiseika Kogyo Co., Ltd.) which exemplifies the isoquinoline-based dye.

An amount of the fluorescent dye (B) contained in the resin composition in accordance with an aspect of the present invention is preferably more than or equal to 0.1 parts by mass, more preferably more than or equal to 0.15 parts by mass, and still more preferably more than or equal to 0.2 parts by mass, relative to 100 parts by mass of the polycarbonate resin (A), from the viewpoint of increasing the color development property and the visibility of the resin composition. The amount of the fluorescent dye (B) contained in the resin composition is preferably less than or equal to 5.0 parts by mass, more preferably less than or equal to 4.0 parts by mass, and still more preferably less than or equal to 3.5 parts by mass, even more preferably less than or equal to 3.0 parts by mass, and further more preferably less than or equal to 2.0 parts by mass, relative to 100 parts by mass of the polycarbonate resin (A), from the viewpoint of suppressing color fading of the resin composition and the viewpoint of increasing the weather resistance.

### [Coloring Agent (C)]

The resin composition in accordance with an aspect of the present invention may further contain other component, provided that the effect of the present invention is obtained. For example, the resin composition may further contain a coloring agent (C). The coloring agent (C) is a coloring agent other than the aforementioned fluorescent dye (B), and is a pigment and a dye other than the fluorescent dye (B). The resin composition preferably further contains the coloring agent (C) from the viewpoint of suppressing color fading over time of the resin composition. The coloring agent (C) may be selected as appropriate from known coloring agents. The coloring agent (C) may be one type of the known coloring agents or may be two or more types of the known coloring agents.

An amount of the coloring agent (C) in the resin composition is preferably more than or equal to 1.0 parts by mass, more preferably more than or equal to 1.1 parts by mass, and still more preferably more than or equal to 1.2 parts by mass, relative to 100 parts by mass of the polycarbonate resin (A), from the viewpoint of suppressing a change in hue of the resin composition under an exposure environment and the viewpoint of increasing the weather resistance. Further, the amount of the coloring agent (C) in the resin composition is preferably less than or equal to 4.0 parts by mass, more preferably less than or equal to 2.5 parts by mass, and still more preferably less than or equal to 2.2 parts by mass, relative to 100 parts by mass of the polycarbonate resin (A), from the viewpoint of vividness of a fluorescent color by the fluorescent dye (B).

Note that the coloring agent (C) may contain a white pigment. An amount of the white pigment contained in the resin composition is preferably more than or equal to 0.03 parts by mass, more preferably more than or equal to 0.1 parts by mass, and still more preferably more than or equal to 0.5 parts by mass, relative to 100 parts by mass of the polycarbonate resin (A), from the viewpoint of improving the luminance of the resin composition. The amount of the white pigment contained in the resin composition is preferably less than or equal to 3.0 parts by mass, more preferably less than or equal to 2.0 parts by mass, and still more preferably less than or equal to 1.5 parts by mass, relative to 100 parts by mass of the polycarbonate resin (A), from the viewpoint of improving the visibility of the resin composition by suppressing the haze of the resin composition.

A total amount of the fluorescent dye (B) and the coloring agent (C) contained in the resin composition is preferably more than or equal to 1.5 parts by mass, and more preferably more than or equal to 2.0parts by mass, relative to 100 parts by mass of the polycarbonate resin (A), from the viewpoint of easily coloring the resin composition in a color of desired chromaticity coordinates (x, y). Further, the total amount of the fluorescent dye (B) and the coloring agent (C) contained in the resin composition is preferably less than or equal to 10.0 parts by mass, more preferably less than or equal to 7.0 parts by mass, and still more preferably less than or equal to 5.0 parts by mass, relative to 100 parts by mass of the polycarbonate resin (A), from the viewpoint of maintaining transparency in the film of the resin composition.

In the resin composition, the fluorescent dye (B) and the coloring agent (C) may be independently contained in each of layered layers. However, it is preferable that the fluorescent dye (B) and the coloring agent (C) be contained in the same layer from the viewpoint of maintaining the hue of the fluorescent dye (B). When the fluorescent dye (B) and the coloring agent (C) are contained in the same layer, it is highly likely that the coloring agent (C) is present near the fluorescent dye (B) even if the coloring of the fluorescent dye (B) is reduced due to, for example, the installation of the resin composition outdoors for a long time. Thus, the coloring agent (C) three-dimensionally reflects the color emitted by the fluorescent dye (B). Therefore, the resin composition can emit a fluorescent color for a long time, and as a result, the visibility, weather resistance, and transparency of the resin composition can be more effectively maintained.

The pigment contained in the coloring agent (C) is preferably at least one type of coloring agent selected from a group consisting of a white coloring agent, a yellow coloring agent, a red coloring agent, and an orange coloring agent, and more preferably at least one type of coloring agent selected from a group consisting of a yellow coloring agent, a red coloring agent, and an orange coloring agent, from the viewpoint of increasing the visibility of the resin composition and the viewpoint of suppressing color fading of the resin composition.

The white coloring agent means a coloring agent whose color shade is white in the color index name. Examples of the white coloring agent include titanium oxide, barium sulfate, and zinc oxide. Examples of a commercially available product of the titanium oxide include “DYMIC MBR 002 White” manufactured by Dainichiseika Kogyo Co., Ltd.

The yellow coloring agent means a coloring agent whose color shade is yellow in the color index name. Examples of the yellow coloring agent include a condensed azo-based coloring agent, an isoindolinone-based coloring agent, and an anthraquinone-based coloring agent.

The condensed azo-based coloring agent means a coloring agent that contains a compound obtained by condensing an acid chloride derivative of an azo dye having an azo bond in a molecule with monoamines or diamines. Examples of the condensed azo-based coloring agent include C.I. Pigment Yellow 93, C.I. Pigment Yellow 95, and C.I. Pigment Yellow 128.

The isoindolinone-based coloring agent means a coloring agent that contains a compound having an isoindolinone skeleton in a molecule. Examples of the isoindolinone-based coloring agent include C.I. Pigment Yellow 109, C.I. Pigment Yellow 110, and C.I. Pigment Yellow 139.

The anthraquinone-based coloring agent means a coloring agent that contains a compound having an anthraquinone skeleton in a molecule. Examples of the anthraquinone-based coloring agent include C.I. Pigment Yellow 24, C.I. Pigment Yellow 99, C.I. Pigment Yellow 108, C.I. Pigment Yellow 123, C.I. Pigment Yellow 147, C.I. Pigment Yellow 199, and C.I. Solvent Yellow 163.

Examples of a commercially available product of the C. I. Pigment Yellow 110 include “DYMIC MBR 443 Yellow” manufactured by Dainichiseika Kogyo Co., Ltd., “Cromophtal (registered trademark) Yellow 2RLP”, “Cromophtal Yellow 2RLTS”, “Cromophtal Yellow3RT”, “Irgazin (registered trademark) Yellow 2RLT”, “Irgazin Yellow 3RLTN”, “Microlith (registered trademark) Yellow 3R-K/KP”, “Microlith Yellow 3R-T”, “Microlith Yellow 3R-WA”, “Microlen Yellow 2RLTS-MC”, and “Microlen Yellow 2RLTS-UA”, and “Unisperse (registered trademark) Yellow 2RLT-S” which are which are manufactured by BASF.

Examples of a commercially available product of the C. I. Solvent Yellow 163 include “DYMIC MBR D-05 Yellow” manufactured by Dainichiseika Kogyo Co., Ltd. and “Oracet (registered trademark) Yellow GHS” manufactured by BASF.

The red coloring agent means a coloring agent whose color shade is red in the color index name. Examples of the red coloring agent include a condensed azo-based coloring agent, a diazo-based coloring agent, an anthraquinone-based coloring agent, a peryleneimide-based coloring agent, a perinone-based coloring agent, a quinacridone-based coloring agent, and a diketopyrrolopyrrole-based coloring agent.

Examples of the condensed azo-based coloring agent of the red coloring agent include C.I. Pigment Red 4, C.I. Pigment Red 166, C.I. Pigment Red 214, and C.I. Pigment Red 221.

The diazo-based coloring agent means a coloring agent that contains a compound having two azo bonds in a molecule. Examples of the diazo-based coloring agent include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 49:2, C.I. Pigment Red 50:1, C.I. Pigment Red 52:1, C.I. Pigment Red 53:1, C.I. Pigment Red 57, C.I. Pigment Red 57:1, C.I. Pigment Red 58:2, C.I. Pigment Red 58:4, C.I. Pigment Red 60:1, C.I. Pigment Red 63:1, C.I. Pigment Red 63:2, C.I. Pigment Red 64:1, C.I. Pigment Red 114, C.I. Pigment Red 144, C.I. Pigment Red 146, C.I. Pigment Red 150, C.I. Pigment Red 151, C.I. Pigment Red 166, C.I. Pigment Red 170, C.I. Pigment Red 171, C.I. Pigment Red 175, C.I. Pigment Red 176, C.I. Pigment Red 178, C.I. Pigment Red 185, C.I. Pigment Red 187, C.I. Pigment Red 193, C.I. Pigment Red 214, C.I. Pigment Red 220, C.I. Pigment Red 221, C.I. Pigment Red 243, C.I. Pigment Red 245, and C.I. Solvent Red 24.

Examples of the anthraquinone-based coloring agent include C.I. Pigment Red 177, C.I. Pigment Red 216, C.I. Disperse Red 22, C.I. Disperse Red 57, C.I. Disperse Red 60, C.I. Solvent Red 4, C.I. Solvent Red 9, C.I. Solvent Red 11, C.I. Solvent Red 15, C.I. Solvent Red 52, C.I. Solvent Red 111, C.I. Solvent Red 168, and C.I. Solvent Red 207.

The peryleneimide-based coloring agent means a coloring agent that contains a compound having a perylenetetracarboxydiimide skeleton in a molecule. Examples of the peryleneimide-based coloring agent include C.I. Pigment Red 149.

The perinone-based coloring agent means a coloring agent that contains a compound having a perinone skeleton in a molecule. Examples of the perinone-based coloring agent include C.I. Solvent Red 135 and C.I. Solvent Red 179.

The quinacridone-based coloring agent means a coloring agent that contains a compound having a quinacridone skeleton in a molecule. Examples of the quinacridone-based coloring agent include C.I. Disperse Red 122 and C.I. Disperse Red 202.

The diketopyrrolopyrrole-based coloring agent means a coloring agent that contains a compound having a diketopyrrolopyrrole skeleton in a molecule. Examples of the diketopyrrolopyrrole-based coloring agent include C.I. Disperse Red 254, C.I. Disperse Red 255, C.I. Disperse Red 264, and C.I. Disperse Red 272.

Examples of a commercially available product of C.I. Pigment Red 149 include “DYMIC MBR 155 Red” manufactured by Dainichiseika Kogyo Co., Ltd.

The orange coloring agent means a coloring agent whose color shade is orange in the color index name. Examples of the orange coloring agent include an isoindolinone-based coloring agent and a diketopyrrolopyrrole-based coloring agent. Examples of the isoindolinone-based coloring agent as the orange coloring agent include C.I. Pigment Orange 61. Examples of the diketopyrrolopyrrole-based coloring agent as the orange coloring agent include C.I. Disperse Orange 71 and C.I. Disperse Orange 73.

In addition, for the purpose of complementary color, the coloring agent (C) may further contain a coloring agent having other color, such as a quinacridone-based coloring agent, an isoindoline-based coloring agent, a perylene-based coloring agent, a perinone-based coloring agent, a thioindigo-based coloring agent, and a quinophthalone-based coloring agent.

### [Light Stabilizer (D)]

The resin composition may further contain a light stabilizer (D) from the viewpoint of improving the light stability of the resin composition. For the light stabilizer (D), a known compound can be used as a light stabilizer. The light stabilizer (D) may be one type of light stabilizer or may be two or more types of light stabilizers.

The molecular weight of the light stabilizer (D) is preferably more than or equal to 500, more preferably more than or equal to 700, and still more preferably more than or equal to 1000, from the viewpoint of suppressing bleeding. Further, the molecular weight of the light stabilizer (D) is preferably less than or equal to 4000, more preferably less than or equal to 3800, and still more preferably less than or equal to 3500, from the viewpoint of the dispersibility of the light stabilizer (D).

The light stabilizer (D) is preferably a hindered amine-based light stabilizer from the viewpoint of maintaining the transparency of the resin composition and preventing the degradation of a resin. The hindered amine-based light stabilizer is a compound in which two carbon atoms adjacent to a nitrogen atom in a piperidine ring each have a plurality of substituents that exhibit steric hindrance action. Examples of the substituents that exhibit the steric hindrance action include a methyl group. Examples of the hindered amine-based light stabilizer include a compound having a 2,2,6,6-tetramethyl-4-piperidyl group and a compound having 1,2,2,6,6-pentamethyl-4-piperidyl group.

Examples of a commercially available product of the hindered amine-based light stabilizer or a composition containing the hindered amine-based light stabilizer include Chimassorb (registered trademark) 119FL, 2020FDL, 944FD, and 944LD which are manufactured by BASF, Tinuvin (registered trademark) 622LD, 123S, 144, 765, 770, 770DF, 770FL, 111FD, 123, and 292, Sanol (registered trademark) LS-770, LS-765, LS-292, LS-2626, LS-744, and LS-440 which are manufactured by Sankyo Co., Ltd., and ADEKA STAB (registered trademark) LA-52, LA-57, LA-62, LA-63P, LA-68, LA-81, LA-82, and LA-87 which are manufactured by ADEKA (all are trade names).

An amount of the light stabilizer (D) contained in the resin composition is preferably more than or equal to 0.1 parts by mass, more preferably more than or equal to 0.15 parts by mass, and still more preferably more than or equal to 0.2 parts by mass, relative to 100 parts by mass of the polycarbonate resin (A), from the viewpoint of increasing the weather resistance of the resin composition. Further, the amount of the light stabilizer (D) contained in the resin composition is preferably less than or equal to 3.0 parts by mass, more preferably less than or equal to 1.5 parts by mass, and still more preferably less than or equal to 1.0 parts by mass, relative to 100 parts by mass of the polycarbonate resin (A), from the viewpoint of holding down the production cost of the resin composition.

### [Ultraviolet Absorbing Agent (E)]

The resin composition preferably further contains an ultraviolet absorbing agent (E) from the viewpoint of improving the weather resistance. One type of ultraviolet absorbing agent may be used, or two or more types of ultraviolet absorbing agents may be used. The molecular weight of the ultraviolet absorbing agent is preferably more than or equal to 300, and more preferably more than or equal to 400, from the viewpoint of preventing fouling on a mold during the molding of the resin composition. The molecular weight of the ultraviolet absorbing agent is not particularly limited and is preferably less than or equal to 1000, and more preferably less than or equal to 800, from the viewpoint of dispersibility.

Examples of the ultraviolet absorbing agent include a benzotriazole-based ultraviolet absorbing agent and a triazine-based ultraviolet absorbing agent. Examples of a commercially available product of the benzotriazole-based ultraviolet absorbing agent include Tinuvin 234 manufactured by BASF and ADEKA STAB LA-31 manufactured by ADEKA (all are trade names). Examples of a commercially available product of the triazine-based ultraviolet absorbing agent include Tinuvin 1577 and 1600 manufactured by BASF and ADEKA STAB LA-F70 manufactured by ADEKA (all are trade names).

An amount of the ultraviolet absorbing agent contained in the resin composition is preferably more than or equal to 0.1 parts by mass, more preferably more than or equal to 0.2 parts by mass, and still more preferably more than or equal to 0.3 parts by mass, relative to 100 parts by mass of the polycarbonate resin (A), from the viewpoint of increasing the weather resistance of the resin composition. Further, the amount of the ultraviolet absorbing agent contained in the resin composition is preferably less than or equal to 5.0 parts by mass, more preferably less than or equal to 4.0 parts by mass, and still more preferably less than or equal to 3.0 parts by mass, relative to 100 parts by mass of the polycarbonate resin (A), from the viewpoint of holding down the production cost of the resin composition.

### [Antioxidant (F)]

The resin composition preferably further contains an antioxidant from the viewpoint of preventing coloring caused by molding of the resin composition, for example, thermal coloring when molded into pellets and films. The antioxidant can be selected as appropriate from compounds known as an antioxidant and may be one type of compound known as an antioxidant or may be two or more types thereof.

Preferable examples of the antioxidant include a phenol-based antioxidant. Examples of the phenol-based antioxidant include a hindered phenol-based compound. The hindered phenol-based compound has a bulky group at an ortho position of a hydroxyl group of a phenol-based compound. Thus, properties of a phenolic hydroxyl group are not exhibited, or the exhibition of the properties of the phenolic hydroxyl group is inhibited.

Examples of a commercially available product of the antioxidant or a composition containing the antioxidant include Irganox (registered trademark) 1010, 1076, 1098, 245, and 3114 manufactured by BASF, and ADEKA STAB AO-20, AO-50, AO-60, AO-80, and AO-330 manufactured by ADEKA (all are trade names).

An amount of the antioxidant contained in the resin composition is preferably more than or equal to 0.01 parts by mass, more preferably more than or equal to 0.02 parts by mass, and still more preferably more than or equal to 0.03 parts by mass, relative to 100 parts by mass of the polycarbonate resin (A), from the viewpoint of being accompanied by coloring caused by molding of the resin composition. Further, the amount of the antioxidant contained in the resin composition is preferably less than or equal to 2.0 parts by mass, more preferably less than or equal to 1.5 parts by mass, and still more preferably less than or equal to 1.0 parts by mass, relative to 100 parts by mass of the polycarbonate resin (A), from the viewpoint of holding down the production cost of the resin composition.

### [Other Additive]

The resin composition may further contain, as an additive, an additional component other than the above-described components, provided that the effect of the present invention is obtained. Examples of the additive include: a thermal stabilizer; a filling agent such as a filler; a neutralizer; a lubricant; an antifogging agent; an anti-blocking agent; a slipping agent; a dispersant; a coloring agent; a flame retardant; an antistatic agent; a conductivity imparting agent; a crosslinking agent; a crosslinking aid; a metal deactivator; a molecular weight regulator; an antimicrobial agent; an antifungal agent; a fluorescent brightening agent; and a light diffusing agent such as an organic diffusing agent or an inorganic diffusing agent.

In addition, the resin composition may further contain an additional resin other than the polycarbonate resin (A), provided that an effect of the present invention is obtained. Examples of the additional resin include a synthetic resin, an elastomer, and a biodegradable resin. Examples of the synthetic resin include aromatic polyester, aliphatic polyester, polyamide, polystyrene, polyolefin, amorphous polyolefin, acrylonitrile-butadiene-styrene copolymer (ABS resin), and acrylonitrile-styrene copolymer (AS resin). Examples of the elastomer include acrylic rubber and butadiene rubber. Examples of the biodegradable resin include polylactic acid and polybutylene succinate. Other resins may be kneaded with the polycarbonate resin (A). That is, the resin composition may be a polymer alloy.

### [Method for Producing Resin Composition]

The resin composition in accordance with an aspect of the present invention can be produced by a method of mechanically melt-kneading the aforementioned materials for the resin composition. Examples of a melt-kneading machine used for the melt-kneading include a single-screw extruder, a twin-screw extruder, a Brabender, a Banbury mixer, a kneader blender, and a roll mill. At the time of kneading, the materials for the resin composition may be kneaded at once. Alternatively, after any part of the components is kneaded, the other remaining components may be added thereto and kneaded. The latter is preferable from the viewpoint of preventing coloring unevenness of the resin composition, in particular, coloring unevenness of a film in a case where the film is formed from the resin composition. In addition, a method of, by using a twin-screw extruder equipped with a vacuum vent, continuously introducing each of the materials for the resin composition into the twin-screw extruder and melt-kneading the materials to obtain the resin composition is preferable from the viewpoint of productivity and quality uniformity.

The kneading temperature during the above-described melt-kneading is usually more than or equal to 150° C., preferably more than or equal to 180° C., and more preferably more than or equal to 200° C. Further, the kneading temperature is usually less than or equal to 280° C., preferably less than or equal to 260° C., and more preferably less than or equal to 250° C. The kneading temperature falling within such a range is preferable from the viewpoint of preventing thermal deterioration of the polycarbonate resin (A) during kneading and the viewpoint of preventing coloring of the resin composition or deterioration in mechanical properties of the resin composition.

Examples of a shape of the resin composition include an agglomeration, a powder, and a pellet. The shape of the resin composition is preferably a pellet in terms of excellent handleability of the resin composition.

### [Film]

A film in accordance with an aspect of the present invention includes the above-described resin composition. For example, the film in accordance with an aspect of the present invention is obtained by molding the above-described resin composition. The film is suitably used as a skin material for a retroreflective sheet disposed on the retroreflective sheet. In this application, the film is preferably a single-layer film. The film has good weather resistance with little change in appearance due to outdoor exposure when used as the skin material for the retroreflective sheet. In addition, the film can be a film having a fluorescent color that satisfies desired chromaticity coordinates (x, y) when used as a skin material for a retroreflective sheet.

### [Thickness]

The thickness of the above-described film is preferably 10 μm to 500 μm, and more preferably 30 μm to 200 μm, from the viewpoint of excellent handleability.

### [Color]

In a case where the film is used for the above-described skin material, disclosed in ASTM D4956 as the chromaticity coordinates (x, y) in the XYZ color system required as a retroreflective member are, for example, the following ranges of the chromaticity coordinates (x, y) of yellow-green, yellow, and orange. The film preferably satisfies any of the ranges of the chromaticity coordinates (x, y) as necessary.

The range of the chromaticity coordinates of yellow-green (Fluorescent Yellow-Green) is a range surrounded by straight lines that sequentially connect four points of (0.387, 0.610), (0.369, 0.546), (0.428, 0.496), and (0.460, 0.540).

The range of the chromaticity coordinates of yellow (Fluorescent Yellow) is a range surrounded by straight lines that sequentially connect four points of (0.479, 0.520), (0.446, 0.483), (0.512, 0.421), and (0.557, 0.442).

The range of the chromaticity coordinates of orange (Fluorescent Orange) is a range surrounded by straight lines that sequentially connect four points of (0.583, 0.416), (0.535, 0.400), (0.595, 0.351), and (0.645, 0.355).

The chromaticity coordinates (x, y) of the film in the XYZ color system are preferably within a range surrounded by straight lines that sequentially connect four points of (0.583, 0.416), (0.535, 0.400), (0.642, 0.305), and (0.692, 0.309) from the viewpoint of increasing the visibility of the retroreflective member. In a case where the chromaticity coordinates of the film are within the above-described range, a retroreflective member having the film exhibits a fluorescent orange color and is suitable for, for example, a retroreflective member that requires high visibility such as a construction sign.

From the above-described viewpoints, the chromaticity coordinates (x, y) of the film in the XYZ color system are more preferably within a range surrounded by straight lines that sequentially connect four points of (0.583, 0.416), (0.535, 0.400), (0.614, 0.330), and (0.662, 0.338), and still more preferably within a range surrounded by straight lines that sequentially connect four points of (0.609, 0.390), (0.558, 0.380), (0.614, 0.330), and (0.662, 0.338).

A Y-value (“luminous reflectance” or “stimulus value”) of the above-described film in the XYZ color system is preferably more than or equal to 10, and more preferably more than or equal to 15, from the viewpoint of achieving good reflection performance when the film is used in the retroreflective member. In addition, the Y-value is preferably less than or equal to 40 from the viewpoint of achieving good visibility when the film is used in the retroreflective member.

The chromaticity coordinates and the Y-value of the film can be determined as appropriate from a measured value of a spectral reflection spectrum of the film. The chromaticity coordinates of the film can be adjusted by the type of the fluorescent dye (B) and the type of the coloring agent (C). The Y-value of the film can be increased by increasing the amount of a coloring agent contained that has a bright color such as yellow.

### [Haze]

A haze of the film described above is preferably more than or equal to 5%, and more preferably more than or equal to 8%, from the viewpoint of achieving good appearance when the film is used in the retroreflective member. Further, the haze of the film is preferably less than or equal to 40%, and more preferably less than or equal to 30%, from the viewpoint of achieving good visibility when the film is used in the retroreflective member.

The haze of the film can be obtained in accordance with JIS K 7136:2000. Further, the haze of the film can be adjusted by changing the amounts of the coloring agents contained or by changing a ratio between the yellow coloring agent and the red coloring agent.

### [Method for Producing Film]

The above-described film can be produced by molding the aforementioned resin composition by a known molding method. Examples of the molding method include a melt extrusion method and a calendar method, and examples of the melt extrusion method include a melt casting method, a T-die method, and an inflation method. The method of molding the resin composition into the film is preferably a T-die method in terms of being excellent in economy.

### [Laminate]

A laminate in accordance with an aspect of the present invention is a laminate of the aforementioned film and a retroreflective sheet. The laminate is, for example, the aforementioned retroreflective member in which a film is disposed as a skin material for a retroreflective sheet. The retroreflective sheet only needs to include a retroreflective element that is constituted by a micro repeated structure which brings about retroreflection. Examples of a retroreflective element layer including the retroreflective element include a spherical lens and a prism. The retroreflective element layer preferably includes a spherical lens or a prism from the viewpoint of improving a retroreflective property of the retroreflective element layer. The retroreflective element layer may have a binder layer for holding a spherical lens or a prism or for bonding with the skin material. Examples of the binder layer include a thermoplastic resin layer.

The retroreflective sheet may be constituted

by only the retroreflective element or may further include a structure other than the retroreflective element. For example, in a case where a film having a prism formed on a surface thereof can be a constituent of a laminate, a side of the film on which the prism is not formed serves as a surface side of a prism type retroreflective sheet, and a side of the film on which the prism is formed serves as a retroreflective element.

There are various types of retroreflective sheets, and any type of retroreflective sheet may be employed. Examples of the retroreflective sheet include an enclosed lens type retroreflective sheet, a capsule type retroreflective sheet, and a prism type retroreflective sheet.

The retroreflective sheet preferably has a structure of two or more layers including at least a substrate and a retroreflective element layer from the viewpoint of improved strength, dimensional stability, waterproofness, and chemical resistance. A form of the substrate is not limited. The form of the substrate may be a sheet form or may be in any of various forms, such as a plate form. Examples of a material of which the substrate is composed include resin, fibers, cloth, and a thin layer metal sheet made of, for example, stainless steel or aluminum. The material may be one type of material or may be two or more types of materials.

The laminate may further have an additional constituent other than the above-described constituent, provided that the effect of the present invention is obtained. Examples of the other constituent include an adhesive layer and a release material layer. The adhesive layer may be a layer that is interposed between the substrate and the retroreflective element layer to bond both of them or may be a layer that is interposed between the film and the retroreflective element layer to bond both of them. A mold release material layer is a layer for protecting an adhesive surface of the adhesive layer and can be constituted by a sheet that can be bonded to and detached from the adhesive layer, such as a mold release sheet or a resin film. An adhesive constituting the adhesive layer and a release material constituting the mold release agent layer can be selected as appropriate from known adhesives and release materials.

### SPECIFIC ASPECT

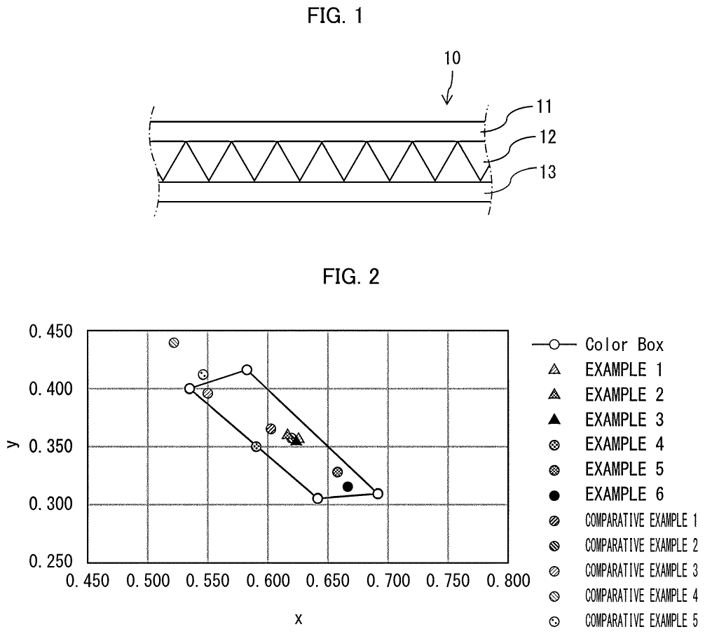

FIG. 1 is a diagram schematically illustrating a layer configuration of an example of a laminate in accordance with an embodiment of the present invention. The laminate illustrated in FIG. 1 represents an example of a prism type retroreflective sheet. As illustrated in

FIG. 1, the laminate 10 is configured in which a film 11, a retroreflective element layer 12, and a substrate 13 are layered in this order.

The film 11 is the aforementioned film in accordance with an aspect of the present invention. The film 11 is a film produced by a T-die method using, as a material, a resin composition in the form of pellets obtained by melt-kneading a polycarbonate resin (A), a fluorescent dye (B), a coloring agent (C), and an optional additive. For example, the film 11 has chromaticity coordinates (x, y) within a range surrounded by straight lines that sequentially connect four points of (0.583, 0.416), (0.535, 0.400), (0.642, 0.305), and (0.692, 0.309) in the aforementioned XYZ color system, and exhibits fluorescent orange.

The retroreflective element layer 12 is constituted by: a spindle-shaped or corrugated plate-shaped prism formed on one surface of the film 11 by hot pressing; and a space formed between the prism and the substrate 13 by partially bonding the prism and the substrate 13. The partial bonding between the prism and the substrate 13 is carried out by, for example, heating a grid pattern portion of a surface of the substrate 13 and heat-fusing the prism of the retroreflective element layer 12 and the hot-melt grid pattern portion of the substrate 13 together.

The substrate 13 is a resin-made plate-like member. For example, from the viewpoint of achieving both weight reduction and strength, the substrate 13 has a plurality of sections in a grid pattern in which a plurality of recesses extending in the longitudinal direction and the lateral direction cross each other on the retroreflective element layer 12 side. The recesses serve as bonding portions that bond the prism.

Aspects of the present invention can also be expressed as follows:

In a retroreflective member, color fading over time of a film containing a fluorescent dye may occur under an exposure environment. Various reasons for such color fading over time of a film are known such as the type of resin of the film, the oxygen permeability of the film, and the stereoisomerization of the fluorescent dye. A laminate in accordance with an aspect of the present invention suppresses color fading over time of a film under an exposure environment. Such color fading over time can be determined and evaluated on the basis of changes in physical property values such as chromaticity or by additionally taking sensory evaluation made by visual observation into consideration. Therefore, the laminate in accordance with an aspect of the present invention is suitable for a retroreflective member for outdoor use. Although a reason why the color fading over time is suppressed in the laminate in accordance with an aspect of the present invention is uncertain, this is presumably because the progress of some kind of mechanism as described above for color fading over time of the fluorescent dye is inhibited by using the polycarbonate resin (A) in a resin material of a film.

As is clear from the above explanation, a first aspect of the present invention is a resin composition comprising: a polycarbonate resin (A) containing a structural unit (a) derived from a dihydroxy compound represented by the aforementioned formula (1); and a fluorescent dye (B). According to the above-described aspect of the present invention, it is possible to provide a colored resin product that contains a fluorescent dye and suppresses color fading over time.

In a second aspect of the present invention, a resin composition is configured such that, in the first aspect, an amount of the fluorescent dye (B) is more than or equal to 0.1 parts by mass, relative to 100 parts by mass of the polycarbonate resin (A). This configuration is more effective from the viewpoint of realizing a laminate that exhibits a sufficient visual effect over time.

In a third aspect of the present invention, a resin composition is configured such that, in the first or second aspect, the polycarbonate resin (A) further contains a structural unit (b) derived from at least one type of dihydroxy compound selected from a group consisting of aliphatic hydrocarbon dihydroxy compounds, alicyclic hydrocarbon dihydroxy compounds, and ether-containing dihydroxy compounds. This configuration is more effective from the viewpoint of increasing the chemical resistance of the polycarbonate resin (A).

In a fourth aspect of the present invention, a resin composition is configured such that, in the third aspect, a molar ratio a/b of the structural unit (a) to the structural unit (b) in the polycarbonate resin (A) is within a range of 40/60 to 90/10. This configuration is more effective from the viewpoint of increasing the heat resistance, mechanical properties, moldability, moist heat resistance, and chemical resistance of the polycarbonate resin (A) adequately from a workable standpoint.

In a fifth aspect of the present invention, a resin composition is configured, in any of the first to fourth aspects, to further comprise a coloring agent (C) containing at least one selected from a group consisting of a dye different from the fluorescent dye (B) and a pigment. This configuration is more effective from the viewpoint of suppressing color fading over time of the resin composition.

In a sixth aspect of the present invention, a resin composition is configured such that, in the fifth aspect, an amount of the coloring agent (C) is 1.0 parts by mass to 4.0 parts by mass, relative to 100 parts by mass of the polycarbonate resin (A). This configuration is more effective from the viewpoint of suppressing a change in hue of the resin composition under an exposure environment and the viewpoint of increasing the weather resistance.

In a seventh aspect of the present invention, a resin composition is configured such that, in the fifth or sixth aspect, a total amount of the fluorescent dye (B) and the coloring agent (C) is 1.5 parts by mass to 10.0 parts by mass, relative to 100 parts by mass of the polycarbonate resin (A). This configuration is more effective from the viewpoint of easily coloring the resin composition in a color of desired chromaticity coordinates and the viewpoint of maintaining the transparency in a film of the resin composition.

In an eighth aspect of the present invention, a resin composition is configured such that, in any one of the first to seventh aspects, a weight average molecular weight of the polycarbonate resin (A) is 20,000 to 100,000. This configuration is more effective from the viewpoint of increasing the impact resistance, chemical resistance, and moist heat resistance of the polycarbonate resin (A).

In a ninth aspect of the present invention, a resin composition is configured such that, in any one of the first to eighth aspects, a glass transition temperature of the polycarbonate resin (A) is 90° C. to 150° C. This configuration is more effective from the viewpoint of increasing the heat resistance of the resin composition.

In a tenth aspect of the present invention, a resin composition is configured such that, in any one of the first to ninth aspects, the fluorescent dye (B) contains at least one type of dye selected from a group consisting of thioxanthen-based dyes, thioindigoid-based dyes, anthraquinone-based dyes, benzoxazole coumarin-based dyes, perylene-based dyes, peryleneimide-based dyes, benzopyran-based dyes, anthracene dyes, and isoquinoline-based dyes. This configuration is more effective from the viewpoint of increasing the transparency of the resin composition and the viewpoint of achieving an excellent hue.

In an eleventh aspect of the present invention, a resin composition is configured such that, in any one of the first to tenth aspects, the fluorescent dye (B) is one or both of a yellow fluorescent dye and a red fluorescent dye. This configuration is more effective from the viewpoint of achieving chromaticity coordinates suitable for the application of a retroreflective member.

In a twelfth aspect of the present invention, a resin composition is configured such that, in any one of the fifth to seventh aspects, the pigment is at least one type of coloring agent selected from a group consisting of a white coloring agent, a yellow coloring agent, a red coloring agent, and an orange coloring agent. This configuration is more effective from the viewpoint of increasing the visibility of the resin composition.

In a thirteenth aspect of the present invention, a resin composition is configured, in any one of the first to twelfth aspects, to further comprise a light stabilizer (D) having a molecular weight of 500 to 4000. This configuration is more effective from the viewpoint of suppressing bleeding and improving the dispersibility of the light stabilizer.

In a fourteenth aspect of the present invention, a resin composition is configured such that, in the thirteenth aspect, the light stabilizer (D) is a hindered amine-based light stabilizer, and an amount of the light stabilizer (D) is 0.1 parts by mass to 3.0 parts by mass, relative to 100 parts by mass of the polycarbonate resin (A). This configuration is more effective from the viewpoint of increasing the weather resistance of the resin composition and the viewpoint of holding down the production cost of the resin composition.

A fifteenth aspect of the present invention is a film comprising a resin composition according to any one of the first to fourteenth aspects. According to this aspect, it is possible to provide a colored resin product that contains a fluorescent dye and suppresses color fading over time.

In a sixteenth aspect of the present invention, a film is configured such that, in the fifteenth aspect, a thickness of the film is 10 μm to 500 μm. This configuration is more effective from the viewpoint of increasing the handleability of the film.

In a seventeenth aspect of the present invention, a film is configured such that, in the fifteenth or sixteenth aspect, chromaticity coordinates (x, y) in an XYZ color system are within a range surrounded by straight lines that sequentially connect four points of (0.583, 0.416), (0.535, 0.400), (0.642, 0.305), and (0.692, 0.309). This configuration is more effective from the viewpoint of increasing the visibility of the film in the application of a retroreflective member.

An eighteenth aspect of the present invention is a method for producing a film, wherein a film according to any one of the fifteenth to seventeenth aspects is produced by a T-die method. According to this aspect, it is possible to provide a colored resin product that contains a fluorescent dye and suppresses color fading over time.

A nineteenth aspect of the present invention is a laminate comprising: a film according to any one of the fifteenth to seventeenth aspects; and a retroreflective sheet. According to this aspect, it is possible to provide a colored resin product that contains a fluorescent dye and suppresses color fading over time.

In a twentieth aspect of the present invention, a laminate is configured such that, in the nineteenth aspect, the retroreflective sheet has a structure of two or more layers including at least a substrate and a retroreflective element layer, and the retroreflective element layer comprises a spherical lens or a prism. This configuration is more effective from the viewpoint of increasing the strength, dimensional stability, waterproofness, and chemical resistance of the laminate and the viewpoint of increasing the retroreflective properties of the retroreflective element layer.

According to the above-described configuration in accordance with an aspect of the present invention, provided is a resin product having excellent visibility and capable of suppressing color fading over time under an exposure environment. This provides stable and clear display outdoors. Thus, it is expected to contribute to achievement of sustainable development goals (SDGs) regarding ensuring of safe and healthy lives.

The present invention is not limited to the aspects described above, but may be altered in various ways within the scope of the claims. The present invention also encompasses, in its technical scope, any aspect derived by combining, as appropriate, technical means disclosed in differing embodiments.

### EXAMPLES

The following will explain an Example of the present invention.

### [Preparation of Resin Materials]

Abbreviations and manufacturers of compounds used in Production Examples and Examples below are as follows.

### [Polycarbonate Resin]

### (Abbreviations and Others)

PC-A1: isosorbide polycarbonate resin (manufactured by Mitsubishi Chemical Corporation; DURABIO D7340R (ISB/CHDM=70:30 (molar ratio))).
PC-A2: isosorbide polycarbonate resin (manufactured by Mitsubishi Chemical Corporation; DURABIO D5380R (ISB/CHDM=50/50 (molar ratio)))
PC-A3: isosorbide polycarbonate resin (manufactured by Mitsubishi Chemical Corporation; DURABIO T7450A (ISB/TCDDM=70/30 (molar ratio)))

### [Dihydroxy Compound]

### (Abbreviations)

ISB: isosorbide
CHDM: 1,4-cyclohexanedimethanol
TCDDM: tricyclodecanedimethanol

A weight average molecular weight Mw of PC-A1 was 35,000. The weight average molecular weight of PC-A1 was measured by gel permeation chromatography (GPC) under the following GPC measurement conditions. The weight average molecular weight Mw of PC-A1 is a standard polystyrene-equivalent value in the following measurement.

### (GPC Measurement Conditions)

Device used: HLC-8320 GPC system manufactured by Tosoh Corporation

Column: 2 columns of TSKgel Super HZM-H (trade name, manufactured by Tosoh Corporation)

Eluent: tetrahydrofuran

Column temperature: 40° C.

Detector: differential refractive index (RI)

A glass transition temperature Tg of PC-A1 was 120° C. The glass transition temperature was calculated from a FOX formula using a value described in a polymer handbook [Polymer HandBook (J. Brandrup, Interscience, 1989)].

The weight average molecular weight Mw Of PC-A2 was 55,000, and the glass transition temperature Tg of PC-A2 was 100° C. The weight average molecular weight Mw of PC-A3 was 38,000, and the glass transition temperature Tg of PC-A3 was 130° C.

The following will explain Production Examples of additional resin materials. Abbreviations and manufacturers in the Production Examples are as follows. Note that, hereinafter, the “part(s)” represents “part(s) by mass”.

### (Abbreviations and Others)

MMA: methyl methacrylate

n-BA: n-butyl acrylate

1,3-BD: 1,3-butylene glycol dimethacrylate

AMA: allyl methacrylate

CHP: cumene hydroperoxide

t-BH: t-butyl hydroperoxide

n-OM: n-octyl mercaptan

EDTA: disodium ethylenediamine tetraacetate

SFS: sodium formaldehyde sulfoxylate (rongalite)

RS610NA: polyoxyethylene alkyl ether sodium phosphate (Phosphanol (registered trademark) RS610NA, manufactured by Toho Chemical Industry Co., Ltd.)

### [Production of Rubber-Containing Polymer A1-1]

Into a container equipped with a stirrer and a cooler, 8.5 parts of ion-exchanged water was charged, and a monomer component (m11-1) including 0.3 parts of MMA, 4.5 parts of n-BA, 0.2 parts of 1,3-BD, and 0.05 parts of AMA and 0.025 parts of CHP, which is a polymerization initiator, were introduced thereinto and mixed by stirring. 1.1 parts of RS610NA as an emulsifier was added to the container with stirring, and stirring was continued for 20 minutes to prepare an emulsified liquid containing the monomer component (m11-1).

186.5 parts of ion-exchanged water was introduced into a reaction vessel equipped with a cooler, and the temperature was raised to 70° C. A mixture prepared by adding 0.20 parts of SFS, 0.0001 parts of ferrous sulfate, and 0.0003 parts of EDTA to 5 parts of ion-exchanged water was introduced into a reaction vessel at once. While being stirred under nitrogen, the emulsified liquid containing the monomer component (m11-1) was added dropwise to the reaction vessel over 8 minutes. The reaction was continued for 15 minutes to obtain a polymer obtained from the monomer component (m11-1).

Subsequently, a monomer component (m11-2) including 1.5 parts of MMA, 22.5 parts of n-BA, 1.0 parts of 1,3-BD, and 0.25 parts of AMA, and 0.016 parts of CHP, which is a polymerization initiator, were added to the reaction vessel over 90 minutes. The reaction was continued for 60 minutes to obtain a rubber polymer (Aa-1). The Tg of the rubber polymer (Aa-1) was-47° C.

Subsequently, a monomer component (m13-1) including 6.0 parts of MMA, 4.0 parts of n-BA, and 0.08 parts of AMA and 0.013 parts of CHP, which is a polymerization initiator, were added dropwise to the reaction vessel over 45 minutes. The reaction was continued for 60 minutes to obtain an intermediate polymer. The Tg of the polymer composed of only the monomer component (m13-1) was 20° C.

Subsequently, a monomer component (m12-1) including 55.2 parts of MMA and 4.8 parts of n-BA, 0.22 parts of n-OM, which is a chain transfer agent, and 0.08 parts of t-BH, which is a polymerization initiator, were added dropwise to the reaction vessel over 140 minutes. The reaction was continued for 60 minutes to obtain latex containing the rubber-containing polymer (A1-1). The Tg of the polymer composed of only the monomer component (m12-1) was 84° C. A mass average particle diameter of the rubber-containing polymer (A1-1) in the latex was 0.12 μm.

The latex containing the rubber-containing polymer (A1-1) was filtered with use of a vibration type filtration device equipped with a stainless steel mesh (average opening of 54 μm) as a filter medium. A filtrate was introduced into an aqueous solution containing 3 parts of calcium acetate to salt out a polymer. The polymer was washed with water, recovered, and then dried to obtain a powdery rubber-containing polymer A1-1. A gel content of the rubber-containing polymer A1-1 was 58%.

### [Preparation of Thermoplastic Polymer A2-1]

ACRYPET (registered trademark) MD manufactured by Mitsubishi Chemical Corporation was prepared. This was regarded as a thermoplastic polymer A2-1. The gel content of the thermoplastic polymer A2-1 was 0%.

### [Preparation of Polycarbonate Resin S-3000]

Iupilon (registered trademark) S3000 (bisphenol A polycarbonate) manufactured by Mitsubishi Engineering-Plastics Corporation was prepared. This was regarded as a polycarbonate resin S-3000.

The following will explain Production Examples of resin compositions. Abbreviations and manufacturers in the Production Examples are as follows.

### (Abbreviations and Others)

Fluorescent dye B-1: DYMIC MBR D-77 Red manufactured by Dainichiseika Kogyo Co., Ltd.

Fluorescent dye B-2: DYMIC MBR D-71 Yellow manufactured by Dainichiseika Kogyo Co., Ltd.

Coloring agent C-1: DYMIC MBR 002 White manufactured by Dainichiseika Kogyo Co., Ltd.

Coloring agent C-2: DYMIC MBR 443 Yellow manufactured by Dainichiseika Kogyo Co., Ltd.

Coloring agent C-3: DYMIC MBR 155 Red manufactured by Dainichiseika Kogyo Co., Ltd.

Light stabilizer D-1: hindered amine-based light stabilizer, Chimassorb (registered trademark) 2020 FD, manufactured by BASF

Ultraviolet absorbing agent E-1: benzotriazole-based ultraviolet absorbing agent, ADEKA STAB LA-31RG, manufactured by ADEKA

Antioxidant F-1: hindered phenol-based antioxidant,

Irganox 1076, manufactured by BASF

### Example 1

The following components in the following amounts were mixed with use of a Henschel mixer to obtain a resin composition 1.
PC-A1: 100 parts
E-1:1.875 parts
D-1:0.2 parts
F-1:0.1 parts
B-1:0.12 parts
B-2:0.2 parts
C-1:0.6 parts
C-2:1.0 parts
C-3:0.12 parts

The resin composition 1 was supplied to a degassing twin-screw kneading extruder (TEM-35B, manufactured by Toshiba Machine Co., Ltd.) heated to 240° C., and was kneaded to obtain pellets 1 of the resin composition 1. The pellets 1 were introduced into a 30 mmφ (diameter) non-vent screw type extruder (L/D=26) equipped with a 150 mm-wide T-die, and were formed into a film by the screw type extruder under conditions of a cylinder temperature of 200° C. to 240° C., a T-die temperature of 240° C., and a cooling roll temperature of 80° C. A resin film produced was wound around a paper tube with a winder. In this way, a resin film 1 which was fluorescently colored and transparent and had a thickness of 75 μm was obtained.

### Examples 2 and 3 and Comparative Examples 1 to 3

A resin film 2 was obtained in the same manner as in the production of the resin film 1, except that PC-A2 was used instead of PC-A1. In addition, a resin film 3 was obtained in the same manner as in the production of the resin film 1, except that PC-A3 was used instead of PC-A1.

Further, a resin film cl was obtained in the same manner as in the production of the resin film 1, except that 60 parts of A1-1 and 40 parts of A2-1 were used instead of PC-A1. In addition, a resin film c2 was obtained in the same manner as in the production of the resin film 1, except that S-3000 was used instead of PC-A1.

Further, a resin film c3 was obtained in the same manner as in the production of the resin film c1, except that the amount of D-1 was changed to 0.25 parts, B-1, B-2, and C-1 were not added, the amount of C-2 was changed to 0.96 parts, and the amount of C-3 was changed to 0.45 parts. Note that the thickness of the resin film c3 was 60 μm.

### Examples 4 to 6

A resin film 4 was obtained in the same manner as in the production of the resin film 2, except that the coloring agents were not added. In addition, a resin film 5 was obtained in the same manner as in the production of the resin film 2, except that the amount of B-1 was changed to 0.9 parts, and the amount of B-2 was changed to 1.5 parts. Further, a resin film 6 was obtained in the same manner as in the production of the resin film 2, except that the amount of B-1 was changed to 1.8 parts, and the amount of B-2 was changed to 3.0 parts.

### Comparative Examples 4 and 5

A resin film c4 was obtained in the same manner as in the production of the resin film 2, except that the fluorescent dyes and C-1 were not added. A resin film c5 was obtained in the same manner as in the production of the resin film 2, except that the fluorescent dyes were not added.

Material compositions of the resin films 1 to 6 and c1 to c5 are shown in Table 1.

TABLE 1

| | Resin materials | | | | | | | | | Fluorescent | | | | |
|---|---|---|---|---|---|---|---|---|---|---|---|---|---|---|
| Resin | PC- | PC- | PC- | | | S- | Additives | | | dyes | | Coloring agents | | |
| films | A1 | A2 | A3 | A1-1 | A2-1 | 3000 | E-1 | D-1 | F-1 | 8-1 | B-2 | C-1 | C-2 | C-3 |
| 1 | 100 | — | — | — | — | — | 1.875 | 0.20 | 0.1 | 0.12 | 0.2 | 0.6 | 1.00 | 0.12 |
| 2 | — | 100 | — | — | — | — | 1.875 | 0.20 | 0.1 | 0.12 | 0.2 | 0.6 | 1.00 | 0.12 |
| 3 | — | — | 100 | — | — | — | 1.875 | 0.20 | 0.1 | 0.12 | 0.2 | 0.6 | 1.00 | 0.12 |
| 4 | — | 100 | — | — | — | — | 1.875 | 0.20 | 0.1 | 0.12 | 0.2 | — | — | — |
| 5 | — | 100 | — | — | — | — | 1.875 | 0.20 | 0.1 | 0.90 | 1.5 | 0.6 | 1.00 | 0.12 |
| 6 | — | 100 | — | — | — | — | 1.875 | 0.20 | 0.1 | 1.80 | 3.0 | 0.6 | 1.00 | 0.12 |
| c1 | — | — | — | 60 | 40 | — | 1.875 | 0.20 | 0.1 | 0.12 | 0.2 | 0.6 | 1.00 | 0.12 |
| c2 | — | — | — | — | — | 100 | 1.875 | 0.20 | 0.1 | 0.12 | 0.2 | 0.6 | 1.00 | 0.12 |
| c3 | — | — | — | 60 | 40 | — | 1.875 | 0.25 | 0.1 | — | — | — | 0.96 | 0.45 |
| c4 | — | 100 | — | — | — | — | 1.875 | 0.20 | 0.1 | — | — | — | 1.00 | 0.12 |
| c5 | — | 100 | — | — | — | — | 1.875 | 0.20 | 0.1 | — | — | 0.6 | 1.00 | 0.12 |

### [Evaluation]

### (1) Transparency

For each of the resin films 1 to 6 and c1 to c5, a total light transmittance (T.T, %) was measured in accordance with JIS K 7361-1:1997.

In addition, for each of the resin films 1 to 6 and c1 to c5, a haze (HAZE, %) was measured in accordance with JIS K 7136:2000.

### (2) Hue

Laminates 1 to 6 and c1 to c5 were each prepared by stacking each of the resin films 1 to 6 and c1 to c5 on a commercially available prism type retroreflective sheet (white) (Nikkalite (registered trademark) CRG manufactured by Nippon Carbide Industries Co., Inc.). For each of the laminates 1 to 6 and c1 to c5, the spectral reflection spectrum was measured from the resin film side under the conditions of 0° illumination for a reflection measurement, 45° circumferential light reception, light D65 of standard illuminant, and 10° field of view to determine the tristimulus values X, Y, and Z in the XYZ color system and determine the chromaticity coordinates (x, y) therefrom.

The transparency of each of the resin films 1 to 6 and c1 to c5 and the hue of each of the laminates 1 to 6 and c1 to c5 are shown in Table 2. In addition, the chromaticity coordinates of each of the laminates 1 to 6 and c1 to c5 are shown in FIG. 2.

TABLE 2

| | Resin films | | | | | | | |
|---|---|---|---|---|---|---|---|---|
| | | | Film | Transparency | | Laminates | | |
| Resin films/ | | Fluorescent | thickness | (%) | | Hue | | |
| laminates | Base resins | dyes | (μm) | T.T | HAZE | Y | x | y |
| 1 | ISB/CHDM = 70/30 | Present | 75 | 35.1 | 53.4 | 23.9 | 0.6254 | 0.3569 |
| 2 | ISB/CHDM = 50/50 | Present | 75 | 35.7 | 37.2 | 22.7 | 0.6171 | 0.3594 |
| 3 | ISB/TCDDM = 70/30 | Present | 75 | 32.8 | 43.1 | 22.0 | 0.6222 | 0.3552 |
| 4 | ISB/CHDM = 50/50 | Present | 75 | 42.4 | 15.0 | 28.3 | 0.5902 | 0.3500 |
| 5 | ISB/CHDM = 50/50 | Present | 75 | 18.1 | 28.2 | 10.7 | 0.6579 | 0.3274 |
| 6 | ISB/CHDM = 50/50 | Present | 75 | 12.6 | 20.5 | 5.6 | 0.6673 | 0.3146 |
| c1 | Acryl | Present | 75 | 38.5 | 24.8 | 19.5 | 0.6036 | 0.3646 |
| c2 | PC | Present | 75 | 38.0 | 30.8 | 21.0 | 0.6196 | 0.3573 |
| c3 | Acryl | Absent | 60 | 52.4 | 8.2 | 12.3 | 0.5511 | 0.3964 |
| c4 | ISB/CHDM = 50/50 | Absent | 75 | 66.8 | 7.7 | 35.4 | 0.5222 | 0.4392 |
| c5 | ISB/CHDM = 50/50 | Absent | 75 | 51.3 | 27.3 | 26.0 | 0.5464 | 0.4115 |

### (3) Weather Resistance

The resin films 1 to 6 and c1 to c5 were each subjected to an accelerated exposure test for 1000 hours by being exposed to light from a xenon arc light source under the condition of a method A of ISO 4892-2:2013. Thereafter, the transparency in (1) above was measured. Further, for the haze, a difference (AHAZE) between before and after the exposure test was determined.

In the same manner as in (2) above except that the resin films 1 to 6 and c1 to c5 after the exposure test were used, laminates were prepared, and the chromaticity coordinates thereof were determined.

### (4) Visual Effect

For the visual effect after the exposure test, evaluations of color fading appearance and fluorescence appearance were made.

### (4-1) Color Fading Appearance

For each of the resin films 1 to 6 and c1 to c5, the hue of the resin film in the laminate before and after the exposure test was visually determined, and a score was given in accordance with the following judgment criterion. Resin films that do not fall under a score of 3 and a score of 1 are judged as a score of 2.

### <Judgment Criterion of Color Fading Appearance>

3: Almost no change in hue is found by a visual observation compared to before the exposure.

2: A slight change in hue can be recognized by a visual observation compared to before the exposure.

1: A color is clearly thinner compared to before the exposure.

### (4-2) Fluorescence Appearance

For each of the resin films 1 to 6 and c1 to c5, the vividness of the resin film in the laminate before and after the exposure test was visually determined, and a score was given in accordance with the following judgment criterion. Resin films that do not fall under a score of 3 and a score of 1 are judged as a score of 2.

### <Judgment Criterion of Fluorescence Appearance>

3: The fluorescence appearance is maintained, and a film stands out vividly compared to before the exposure.

2: Vividness is lacking somewhat compared to before the exposure.

1: Vividness is lacking compared to before the exposure.

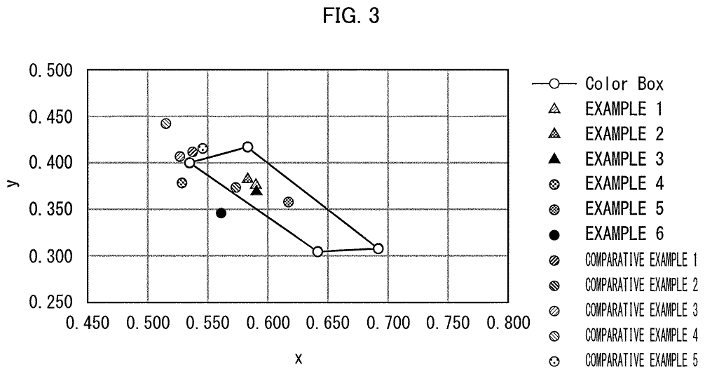

The transparency of each of the resin films 1 to 6 and c1 to c5 after the accelerated light exposure test and the hue and the color fading appearance, and the fluorescence appearance of each of the laminates 1 to 6 and c1 to c5 after the accelerated light exposure test are shown in Table 3. In addition, the chromaticity coordinates of each of the laminates 1 to 6 and c1 to c5 after the accelerated exposure test are shown in FIG. 3.

TABLE 3

| | Resin films | | | | | |
|---|---|---|---|---|---|---|
| Resin | | | Film | Transparency | | |
| films/ | | Fluorescent | thickness | (%) | | |
| laminates | Base resins | dyes | (μm) | T.T | HAZE | ΔHAZE |
| 1 | ISB/CHDM = 70/30 | Present | 75 | 42.8 | 50.3 | 3.0 |
| 2 | ISB/CHDM = 50/50 | Present | 75 | 45.8 | 30.8 | 6.4 |
| 3 | ISB/TCDDM = 70/30 | Present | 75 | 39.5 | 39.0 | 4.1 |
| 4 | ISB/CHDM = 50/50 | Present | 75 | 63.3 | 11.3 | 3.7 |
| 5 | ISB/CHDM = 50/50 | Present | 75 | 26.9 | 34.8 | −6.6 |
| 6 | ISB/CHDM = 50/50 | Present | 75 | 17.9 | 40.7 | −20.2 |
| c1 | Acryl | Present | 75 | 59.8 | 17.1 | 7.7 |
| c2 | PC | Present | 75 | 50.9 | 37.5 | −6.7 |
| c3 | Acryl | Absent | 60 | 58.4 | 8.5 | −0.4 |
| c4 | ISB/CHDM = 50/50 | Absent | 75 | 68.5 | 9.3 | −1.6 |
| c5 | ISB/CHDM = 50/50 | Absent | 75 | 53.8 | 26.9 | 0.4 |

| Resin | Laminates | | | | |
|---|---|---|---|---|---|
| films/ | Hue | | | fading | |
| laminates | Y | x | y | appearance | appearance |
| 1 | 24.2 | 0.5898 | 0.3759 | 3 | 3 |
| 2 | 22.1 | 0.5827 | 0.3821 | 3 | 3 |
| 3 | 22.3 | 0.5906 | 0.3696 | 3 | 3 |
| 4 | 37.9 | 0.5285 | 0.3786 | 2 | 3 |
| 5 | 20.4 | 0.6180 | 0.3574 | 3 | 3 |
| 6 | 14.1 | 0.5605 | 0.3470 | 2 | 3 |
| c1 | 21.1 | 0.5372 | 0.4111 | 3 | 1 |
| c2 | 22.9 | 0.5735 | 0.3731 | 3 | 1 |
| c3 | 13.6 | 0.5272 | 0.4065 | 2 | 3 |
| c4 | 35.5 | 0.5151 | 0.4414 | 3 | 1 |
| c5 | 26.5 | 0.5452 | 0.4154 | 3 | 1 |

### [Consideration]

The “Color Box” in FIGS. 2 and 3 shows a range formed by straight lines that sequentially connect four points of (0.583, 0.416), (0.535, 0.400), (0.642, 0.305), and (0.692, 0.309). This range indicates a suitable range of chromaticity coordinates in the XYZ color system from the viewpoint of increasing the visibility of the aforementioned retroreflective member.

Regarding the chromaticities of all of the laminates of Examples 1 to 3 and Comparative Examples 1 to 3 after the exposure test, the chromaticity coordinates are shifted upward to the left. The laminates 1 to 3 of Examples 1 to 3 are all located within the “Color Box” before and after the exposure test. In addition, the laminates 1 to 3 show good judgment results on both the color fading appearance and the fluorescence appearance. The laminates c1 and c3 of Comparative Examples 1 and 3 after the exposure test are all located outside the “Color Box”, and it is found that a change in color has occurred more remarkably. In addition, the laminate c1 becomes clearly insufficient over time in terms of both the color fading appearance and the fluorescence appearance. The laminate c3 is sufficient over time in terms of the color fading appearance, but becomes clearly insufficient in terms of the fluorescence appearance.

The laminate c2 of Comparative Example 2 is located within the “Color Box” even after the exposure test, but is more significantly shifted than the laminates of the Examples. As is clear from Tables 2 and 3, the haze of the laminate c2 of Comparative Example 2 is significantly decreased after the exposure test, and it is found that the transparency of the laminate c2 of Comparative Example 2 is deteriorated. In addition, the laminate c2 becomes insufficient over time in terms of both the color fading appearance and the fluorescence appearance.

Although the laminates 4 to 6 of Examples 4 to 6 are located within the “Color Box” before the exposure test, the chromaticity coordinates of the laminates 4 and 6 after the exposure test are shifted upward to the left. The laminates 4 and 6 are located outside the “Color Box”, and the laminate 5 is located within the “Color Box”. In addition, as is clear from Table 3, the laminate 5 exhibits a good visual effect over time. Regarding the laminates 4 and 6, an apparent hue decreases over time, but apparent vividness is sufficiently maintained. As a result, the laminates 4 and 6 exhibit a sufficient visual effect over time.

Both of the laminates c4 and c5 of Comparative Examples 4 and 5 are located outside the “Color Box” before and after the exposure test. Both of the laminates c4 and c5 are sufficient over time in terms of the color fading appearance, but become clearly insufficient in terms of the fluorescence appearance.

From the above results, it is found that the laminates 1 to 6 of Examples 1 to 6 each containing a polycarbonate resin (A) containing a structural unit (a) derived from a dihydroxy compound represented by the formula (1) and a fluorescent dye (B) suppress color fading under an exposure environment over a long period of time. This is presumably because the polycarbonate resin (A) acts on the mechanism of color fading of the fluorescent dye (B) to suppress color fading over time of the fluorescent dye (B).

### INDUSTRIAL APPLICABILITY

The present invention is applicable to a resin product that is colored with a fluorescent dye.

### REFERENCE SIGNS LIST

10: laminate
11: film
12: retroreflective element layer
13: substrate

1. A resin composition comprising: a polycarbonate resin (A) containing a structural unit (a) derived from a dihydroxy compound represented by the following formula (1); and a fluorescent dye (B).

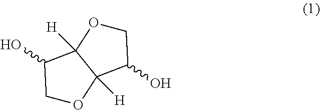

2. The resin composition according to claim 1, wherein an amount of the fluorescent dye (B) is more than or equal to 0.1 parts by mass, relative to 100 parts by mass of the polycarbonate resin (A).

3. The resin composition according to claim 1, wherein the polycarbonate resin a (A) further contains structural unit (b) derived from at least one type of dihydroxy compound selected from a group consisting of aliphatic hydrocarbon dihydroxy compounds, alicyclic hydrocarbon dihydroxy compounds, and ether-containing dihydroxy compounds.

4. The resin composition according to claim 3, wherein a molar ratio a/b of the structural unit (a) to the structural unit (b) in the polycarbonate resin (A) is within a range of 40/60 to 90/10.

5. The resin composition according to claim 1, further comprising a coloring agent (C) containing at least one selected from a group consisting of a dye different from the fluorescent dye (B) and a pigment.

6. The resin composition according to claim 5, wherein an amount of the coloring agent (C) is 1.0 part by mass to 4.0 parts by mass, relative to 100 parts by mass of the polycarbonate resin (A).

7. The resin composition according to claim 5, wherein a total amount of the fluorescent dye (B) and the coloring agent (C) is 1.5 parts by mass to 10.0 parts by mass, relative to 100 parts by mass of the polycarbonate resin (A).

8. The resin composition according to claim 1, wherein a weight average molecular weight of the polycarbonate resin (A) is 20,000 to 100,000.

9. The resin composition according to claim 1, wherein a glass transition temperature of the polycarbonate resin (A) is 90° C. to 150° C.

10. The resin composition according to claim 1, wherein the fluorescent dye (B) contains at least one type of dye selected from a group consisting of thioxanthen-based dyes, thioindigoid-based dyes, anthraquinone-based dyes, benzoxazole coumarin-based dyes, perylene-based dyes, peryleneimide-based dyes, benzopyran-based dyes, anthracene dyes, and isoquinoline-based dyes.

11. The resin composition according to claim 1, wherein the fluorescent dye (B) is one or both of a yellow fluorescent dye and a red fluorescent dye.

12. The resin composition according to claim 5, wherein the pigment is at least one type of coloring agent selected from a group consisting of a white coloring agent, a yellow coloring agent, a red coloring agent, and an orange coloring agent.

13. The resin composition according to claim 1, further comprising a light stabilizer (D) having a molecular weight of 500 to 4000.

14. The resin composition according to claim 13, wherein the light stabilizer (D) is a hindered amine-based light stabilizer, and an amount of the light stabilizer (D) is 0.1 parts by mass to 3.0 parts by mass, relative to 100 parts by mass of the polycarbonate resin (A).

15. A film comprising a resin composition according to claim 1.

16. The film according to claim 15, wherein a thickness of the film is 10 μm to 500 μm.

17. The film according to claim 15, wherein chromaticity coordinates (x, y) in an XYZ color system are within a range surrounded by straight lines that sequentially connect four points of (0.583, 0.416), (0.535, 0.400), (0.642, 0.305), and (0.692, 0.309).

18. A method for producing a film, wherein a film according to claim 15 is produced by a T-die method.

19. A laminate comprising: a film according to claim 15; and a retroreflective sheet.

20. The laminate according to claim 19, wherein the retroreflective sheet has a structure of two or more layers including at least a substrate and a retroreflective element layer, and the retroreflective element layer comprises a spherical lens or a prism.
